(19) United States
(12) Patent Application Publication
(10) Pub. No.: US 2004/0217736 A1
(43) Pub. Date: Nov. 4, 2004

(54) Method and device for carrying out an automatic charge state compensation

(76) Inventor: Claus Bischoff, Stuttgart (DE)

Correspondence Address: KENYON & KENYON, ONE BROADWAY, NEW YORK, NY, 10004, US

(21) Appl. No.: 10/485,779

(22) PCT Filed: Jun. 19, 2002
(86) PCT No.: PCT/DE02/02240

(30) Foreign Application Priority Data
Aug. 8, 2001 (DE) 101 39 048.3

(51) Int. Cl. H02J 7/00

(52) U.S. Cl. 320/119

(57) ABSTRACT

A method and a device for implementing a charge-state equalization among the cells of a vehicle battery are described. This charge-state equalization is carried out under the control of a vehicle-side control unit that includes the vehicle management and the vehicle control device. The charging currents required for the charge-state equalization are provided by a secondary battery of the vehicle and conveyed from there to the vehicle battery when the need for a charge-state equalization is detected.

### FIELD OF THE INVENTION

The present invention relates to a method and a device for implementing an automatic charge equalization.

### BACKGROUND INFORMATION

In view of more stringent environmental legislation, most automotive manufacturers have developed prototype vehicles having hybrid drives. In addition to a fuel tank, such motor vehicles also include an electrical energy store for the supply of the electrical drive units.

This additional energy store plays a much more pivotal role in the vehicle operation than it does in conventional vehicles. For example, it is meant to allow functions such as braking-energy recuperation, electrical driving, boost operation and the driving of electrical auxiliary systems when the engine is at a standstill or when an engine is started.

The high demands these functions place on the battery require the use of heavy-duty batteries.

In many cases, a nickel-metal hydride battery is used in this context. Such batteries have a very high power density and are very easily cyclizable. For instance, in the capacity range between 30 and 70%, they are able to work at the full charge and discharge power. When the battery reaches charge states of more than 90%, the charging currents must be regulated down to a considerable extent. In these states, the battery cells are only able to take up heavily reduced electric power. Their internal resistance is so high that they mostly generate heat. If one were to charge the battery with excessive charge currents, it would no longer be possible to dissipate the corresponding heat flows via a cooling device, and the cells would be destroyed.

Due to manufacturing tolerances and locally fluctuating environmental influences, the individual cells of NiMH batteries tend to drift, especially in heavily cyclical loads, i.e., the charge of the individual cells drifts off. If this drift becomes too great during operation, it severely restricts the performance of the battery. The reasons for this are explained in the following on the basis of a simplified 3-cell battery. Generally, a battery-management system assigned to the battery operates on the basis of an averaged charge-state value SOC*, which corresponds to the averaged value of the charge states of the battery cells. It should be assumed here that this averaged charge-state value is SOC*=70%. In an optimal battery, the charge-state value of cells 1 to 3 would also correspond to the averaged charge-state value SOC*:

SoC₁=SOC₂=SOC₃=SOC* (1)

However, in a real battery, a certain drift occurs due to the aforementioned reasons; that is, while the battery-management system continues to work with the averaged charge-state value SOC*=70%, the charge-state values of the individual cells deviate from each other:

SOC₁≠SOC₂≠SOC₃≠SOC* (2)

For example, the charge-state value of the individual battery cells might assume the following values when a slight drift exists: SOC₁=75%; SOC₂=70%, SOC₃=65%. If strong drift is present, the charge-state values of the battery cells drift further apart and have the following values, for instance: SOC₁=95%; SOC₂=70%; SOC₃=45%. The averaged charge-state value SOC* still amounts to 70% in this case.

As long as the drift is within narrow limits, it has no negative effects on the battery operation. However, if the battery is loaded in a heavily cyclical manner over a longer period of time, it may happen, even at average charge-state values, that battery cell 1, drifting upward, reaches the overload limit. Since this state is safety-critical for the battery, the battery-management system limits the charging current. Therefore, the battery, which on average has reached only 70% of its nominal charge, cannot be charged further.

Since this would constitute a very serious limiting of the operating characteristic, an equalizing charge is implemented as soon as the battery management system detects strong drift. In such an equalizing charge, a heavily down-regulated current I_{Min} corrects the drifting battery cells up to the upper charge-state threshold.

In the NiMH batteries currently used in vehicles, this equalizing charge is implemented within the framework of vehicle service work using a charging device connected to the public power supply. This costly procedure is required because the minimum current I_{Min} must be present in a defined manner, such that the heat emitted by the already fully charged cells may be dissipated at all times via the cooling device.

### SUMMARY

A method and a device according to the present invention may have the advantage that the charge-state equalization among the battery cells is carried out fully automatically whenever necessary, without this requiring a service facility and a charger connected to the public power supply. This fully automatic charge equalization is carried out with the aid of the generator of the vehicle electrical system and a secondary battery of the respective vehicle. The sequencing control and monitoring of the charge-state equalization is assumed by the vehicle control and the battery management system. The vehicle electrical system is completely autonomous here.

### BRIEF DESCRIPTION OF THE DRAWINGS

On the basis of the drawings, the following gives a more detailed explanation of an exempary embodiment of the present invention.

FIG. 1 shows a flow chart to illustrate a method for implementing an automatic charge-state equalization.

FIG. 2 shows a block diagram of a device for implementing an automatic charge-state equalization.

FIG. 3 shows a diagram to illustrate the Bellman Principle.

### DETAILED DESCRIPTION OF EXAMPLE EMBODIMENT

In the following exemplary embodiment, it is assumed that a high-capacity battery or traction battery having three battery cells is provided in a motor vehicle. Due to cyclical loading, the charge state of the battery cells manifests considerable drift during vehicle operation.

An onboard secondary battery is charged by the vehicle generator during this vehicle operation. This secondary battery may have considerably smaller dimensions than the high-capacity battery or traction battery, but it should hold adequate energy. This secondary battery may be an AGM lead-acid battery, for example.

During vehicle operation, the high-capacity or traction battery, which is designed as NiMH battery, is charged as well. In this charging, it leaves the setpoint charge state for normal operation, which generally is between 50% and 60%, and reaches a critical charge-state range, which is approximately 95%. Once this range is reached, the battery management system sets the charging currents such that the highest possible degree of charging efficiency is achieved.

Since the NiMH battery is no longer able to receive any higher charging currents in this charge-state range, the battery management system must strictly limit the battery charging currents, which means that the vehicle control must temporarily forego braking-energy recuperation. However, the battery remains fully operable in the discharge direction, to start the engine, for example.

Should the battery-engine management detect the need for a charge-state equalization, such may be carried out. In the process, it is detected that the vehicle is shut off over a longer period of time, for instance by ascertaining whether the vehicle is locked in the shut-off state. Subsequently, the minimum currents required to correct or charge the cells that have a lower charge state are sent from the secondary battery to the NiMH battery via a resistor. When the battery management detects that all cells of the NiMH battery have reached their upper charge-state threshold, it switches back to normal operation again.

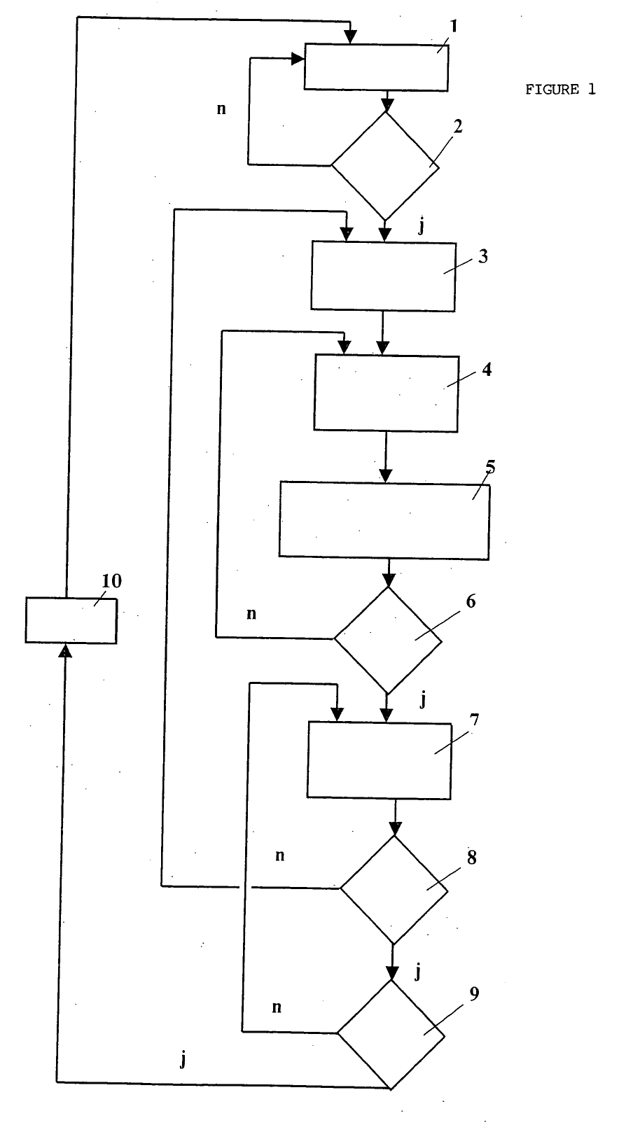

Such a charge-state equalization is discussed in greater detail in the following on the basis of the flow chart illustrated in FIG. 1.

In step 1, the vehicle is in normal operation in which it is possible that the charge states of the individual battery cells of the high-capacity battery or traction battery exhibit drift.

In step 2, a query is implemented whether charge-state equalization is necessary or not. This query is made by the battery management system. If the query shows that no charge-state equalization is needed, it is returned to step 1. If charge-state equalization is considered necessary, a move to step 3 takes place.

In step 3, the vehicle generator brings the secondary battery to its full charge state. In the subsequent step 4, the high-capacity or traction battery is brought into charging readiness. This is followed in step 5 by a disabling of those driving functions of the motor vehicle that require high battery charging currents, such as braking-energy recuperation.

In step 6, a query is then implemented whether the vehicle is shut off. If this is not the case, there is a return to step 4. However, if the vehicle is shut off, step 7 follows.

In step 7, the battery cells of the traction battery having a lower charge are recharged or corrected, using charging current from the secondary battery.

In step 8, a query is launched whether the vehicle is still shut off. If this is not the case, there is a return to step 3. However, if the vehicle is still shut off, an additional query occurs in step 9 whether the charge-state equalization has been concluded or not. If this is not the case, there is a return to step 7.

However, if the charge-state equalization has been concluded, the charging readiness of the traction battery is cancelled in step 10, i.e., the charge state is returned to the normal charge-state operating window. It is then returned to step 1, that is, to normal operation.

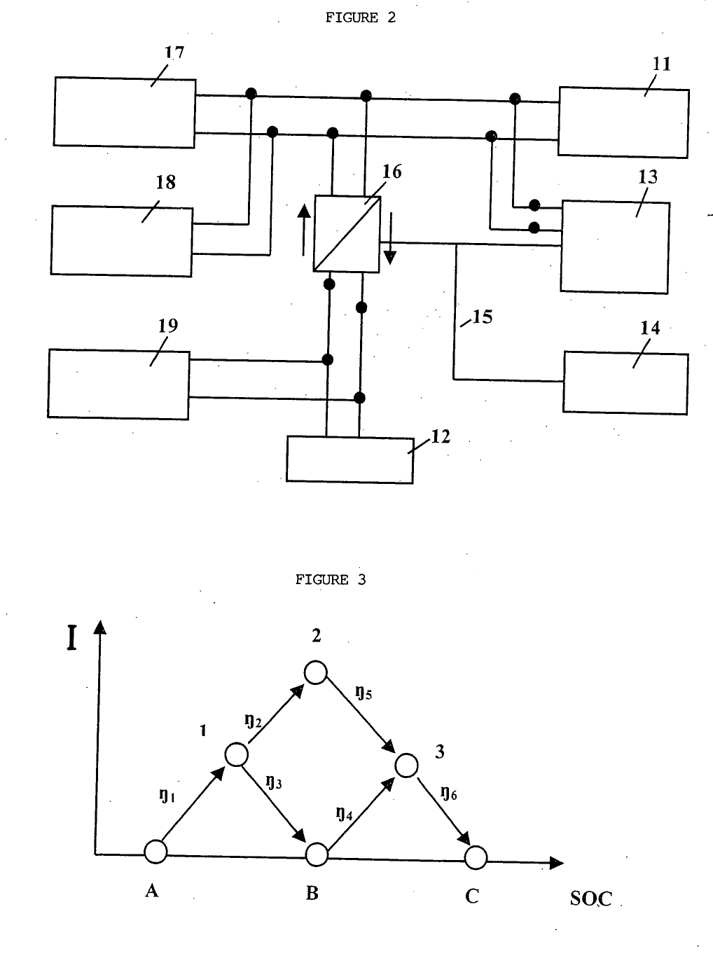

FIG. 2 shows a block diagram of a device for implementing an automatic charge-state equalization in a motor vehicle having a twin-voltage electrical system, such as a 14V/42V vehicle electrical system.

The shown vehicle electrical system has a 26 Ah-NiMH traction battery 11 on which, that is, on whose cells, the charge-state equalization is to be performed. This traction battery 11 is part of the 42 vehicle electrical system, which also includes a 42V load circuit 17 and an e-machine 18.

A lead-acid battery 12, which is also installed in the vehicle and is a component of the 14V vehicle electrical system, is used as secondary battery. As described earlier, this secondary battery is used for charge-state equalization, the two components of the vehicle electrical system being connected via a bi-directional d.c. voltage converter 16.

Within the framework of this charge-state equalization, traction battery 11 must be brought from a given initial charge state to a target charge-state range that is generally above 95%. In this target charge-state range, the battery cell having the highest output or initial charge state has reached a charge state of 100%, for example. The charge-state adjustment or shift is able to be performed on the basis of the Bellman principle in a manner that optimizes efficiency. This Bellman principle states that the optimum path from an initial state to a final state results from the sum of the optimal steps along intermediate states.

This is discussed on the basis of FIG. 3 in which charge current I is plotted along the ordinate and charge state SOC along the abscissa. If the correlation

η₁·η₂·η₄·η₆>η1·η₂·η₅·η₆

holds for the illustration shown in FIG. 3, then the path

A-1-B-3-C

is the path of optimum efficiency from A to C,

η₁, . . . , η₆

being efficiency data along the intermediate states.

In the same manner, an offline, efficiency-optimized determination of a charge strategy for each possible charge-state adaptation step may be made, i.e., a charging current that is optimized from the viewpoint of efficiency. The optimum currents I associated with the respective charge step are stored in battery-management system 13. If the charge state of the battery is to be increased within the framework of a charge-state equalization, the charge state may be corrected along the lines of an optimized individual charge characteristic curve; in the above example, this is implemented on the basis of the charge characteristic curve

A-1-B-3-C.

For the actual charge-state equalization, battery management system 13, having detected the need for charge-state equalization, transmits a status flag to vehicle control device 14, using CAN bus 15 of the vehicle. Vehicle control device 14 then checks whether the charge-state equalization may be carried out and, if this is the case, disables braking-energy recuperation and sends a release signal to battery management 13 via CAN bus 15.

Battery management 13 thereupon brings traction battery 11 into charge-readiness operation in that it shifts the operating window of the battery out of the average charge-state range and allows a charge to be received until one of the battery cells has reached a charge state of approximately 100%.

In the process, e-machine 18, acting as the generator, is instructed by vehicle control device 14 to bring traction battery 11 into the higher charge state via an additional power packet and to bring lead-acid battery 12 into a fully charged state via bi-directional d.c. voltage converter, and to maintain it in this state. In doing so, battery management 13 is able to set the charging currents of both batteries according to the setpoint selections calculated offline, using vehicle control device 14 and d.c. voltage converter 16.

If the vehicle is locked in the shut-off state, the actual charge-state equalization is carried out in which lead-acid battery 12 delivers the current required for the charge-state equalization via d.c. voltage converter 16, the current being in the range of approximately 3 to 5 A. Since both the 14V vehicle electrical system and also the 42V vehicle electrical system are in the rest state during this charge-state equalization, in which no dynamic loads by other consumers occur, the current required for the charge-state equalization may be adjusted very well and in a precise manner.

When all battery cells have attained their upper charge-state threshold of approximately 100%, battery management 13 reports the conclusion of the charge-state equalization procedure by providing a status flag on CAN bus 15. Battery management 13 then shifts the charge state operating window back into the normal working range in which a higher discharge of the battery is allowed again. Vehicle control 14 deactivates the additional power packet requested from e-machines 18 for initiating the charge-state equalization.

If the vehicle is operated again before the charge-state equalization has been concluded, vehicle control 14 abandons the charge-state equalization. However, together with a battery management 13, it ensures that NiMH battery 11 is brought into the higher charge state and secondary battery 12 into the full charge state as quickly as possible after the combustion engine is started. In this manner, it is possible to initiate a new attempt for a charge-state equalization as soon as the vehicle is shut off again.

1-14 (cancelled).

15. A method for implementing a charge-state equalization among cells of a vehicle battery, comprising:
charging of a secondary battery of a vehicle during vehicle operation;
detecting a need for charge-state equalization during vehicle operation;
bringing the vehicle battery into the charge-readiness state;
checking whether a charge-state equalization may be implemented; and
supplying a charging current from the secondary battery to the vehicle battery.

16. The method as recited in claim 15, wherein the checking step includes ascertaining whether the vehicle is locked in a shut-off state.

17. The method as recited in claim 15, further comprising:
deactivating vehicle functions that require high battery charging currents between detecting the need for a charge-state equalization and supplying the charging current from the secondary battery to the vehicle battery.

18. The method as recited in claim 15, further comprising:
after the supply of the charging current from the secondary battery to the vehicle battery has commenced, checking repeatedly whether the charge-state equalization may be continued and, if so, continuing the charge-state equalization, and if not, interrupting the charge-state equalization.

19. The method as recited in claim 15, further comprising:
after the supply of the charging current from the secondary battery to the vehicle battery has commenced, checking repeatedly whether the charge-state equalization has been concluded and, if so, cancelling the charge-state equalization, and if not, continuing, the case, the charge-state equalization.

20. The method as recited in claim 15, wherein the steps of the method run automatically.

21. The method as recited in claim 20, wherein the steps of the method run automatically under control of a control device.

22. The method as recited in claim 21, wherein the steps of the method run automatically under the control of the control device, the control device including a battery management and a vehicle control device of the vehicle.

23. A device for implementing a charge-state equalization among cells of a vehicle battery, comprising:
a vehicle battery having a plurality of cells;
a vehicle-side secondary battery; and
a vehicle-side control device to detect a need for a charge-state equalization, bring the vehicle battery into a charge-readiness state, ascertain whether a charge-state equalization may be implemented, and control a supply of a charging current from the secondary battery to the vehicle battery.

24. The device as recited in claim 23, wherein the control device includes a battery management and a vehicle control device of the vehicle.

25. The device as recited in claim 23, further comprising:
a d.c. voltage converter provided between the secondary battery and the vehicle battery, via which the charging current is supplied.

26. The device as recited in claim 25, wherein the device is part of a twin-voltage electrical system, the secondary battery being a component of a first part of the twin-voltage vehicle electrical system, and the vehicle battery being a component of a second part of the twin-voltage vehicle electrical system, and wherein the d.c. voltage converter is provided between the two parts of the twin-voltage vehicle electrical system.

27. The device as recited in claim 23, wherein the control device is configured to cancel the charge-readiness state of the vehicle battery after the charge-state equalization has been completed.

28. The device as recited in claim 23, wherein the control unit is used to deactivate vehicle functions that require high battery-charging currents.
